(19) United States
(12) Patent Application Publication
(10) Pub. No.: US 2007/0253026 A1
(43) Pub. Date: Nov. 1, 2007

(54) Frame printing device and frame printing system

(75) Inventors: Kenji Sakuda, Nagano (JP); Hideki Morozumi, Nagano (JP); Yoshinao Kitahara, Nagano (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/240,744

(22) Filed: Sep. 30, 2005

(30) Foreign Application Priority Data
Sep. 30, 2004 (JP) P2004-288713

(51) Int. Cl. G06K 1/00

(52) U.S. Cl. 358/1.18

(57) ABSTRACT

A communicator is connected, through a network, to a predetermined server including first frame image data and to a display device operable to select the first frame image data in association with first selection screen information linked to the first frame image data. An acquirer is adapted to acquire the first frame image data from the predetermined server through the communicator. A transmitter is adapted to transmit the first selection screen information to the display device through the communicator. A printer is adapted to print an image on a medium in association with the image data and the first frame image data selected by the display device.

### BACKGROUND OF THE INVENTION

The present invention relates to a frame printing device and a frame printing system.

WO2004/021164 has disclosed a printing system. The printing system has a computer and a printer connected to each other. The computer gives the printer an instruction for printing an image. The printer prints the image specified by the computer onto a paper.

In addition to the printing system having a printer connected to a computer as in WO2004/021164, there is a frame printing system having a printer connected to a DSC (Digital Still Camera) and serving to synthesize a frame image selected in the DSC and an image imaged by the DSC and to print the image thus synthesized.

The frame image to be used for the frame print is selected depending on an image to be combined or the taste of a user. In some cases, moreover, a frame image to be selected by the user is influenced by a vogue at that time. For this reason, the vendor of the printer supplies a frame image to be used in the frame print from a server on the internet. The frame image is supplied from the server on the Internet so that a distribution cost can be reduced differently from the case in which the frame image is offered through a memory card.

As in WO2004/021164, in the frame printing system using a computer, it is possible to carry out the frame print utilizing the frame image offered through the internet by downloading the frame image to the computer.

However, the digital TV receiver does not correspond to the frame print even if it has a function of the Web browser. As a result, in case of the frame printing system in which the digital TV receiver and the printer are connected to each other through the network, it is impossible to carry out the frame print by using a frame image present on the server of the internet.

### SUMMARY

It is an advantage of the invention to obtain a frame printing device and a frame printing system which can carry out frame print in a printing system constituted by a display device such as a digital TV receiver and a printer.

According to the present invention there is provided:

a printing device storing image data, the printing image comprising:

a communicator connected, through a network, to a predetermined server including first frame image data and to a display device operable to select the first frame image data in association with first selection screen information linked to the first frame image data;

an acquirer adapted to acquire the first frame image data from the predetermined server through the communicator;

a transmitter adapted to transmit the first selection screen information to the display device through the communicator; and

a printer adapted to print an image on a medium in association with the image data and the first frame image data selected by the display device.

According to an aspect of the invention, the printing device can select the frame image on the server by the display device and can carry out the frame print by using the frame image selected by the display device. As a result, the frame print can be performed in a printing system constituted by the display device and the printing device.

The printing device according to the invention may have the following structure in addition to the device described above. More specifically, the printing device further includes a receiver adapted to receive second selection screen information having a link linked to second frame image data from the predetermined server through the communicator; and a generator adapted to convert the link into request information so as to generate third selection screen information having the request information, the acquirer receives one of the request information from the display device and acquires one of the second frame image data corresponding to the one of the request information from the predetermined server, and the transmitter transmits forth selection screen information having the second frame image data to the display.

According to an aspect of the invention, the printing device can acquire, from the server, the frame image selected by the display device. In addition, when the frame image to be printed by the display device is selected, it is possible to immediately start the frame print by using the frame image which has already been acquired.

The printing device according to the invention may have the following structure in addition to the device described above. More specifically, the printing device further includes a receiver adapted to receive second selection screen information having a link linked to second frame image data from the predetermined server through the communicator; and a generator adapted to convert the link into request information so as to generate third selection screen information having the request information, the acquirer receives first one of the request information from the display device and acquires one of the second frame image data corresponding to the first one of the request information from the predetermined server, and the transmitter transmits forth selection screen information having the one of the second frame image data and generated by the generator in association with second one of the request information, to the display.

According to an aspect of the invention, the printing device can acquire, from the server, the frame image selected by the display device. In addition, it is possible to execute the acquirement of the frame image and the print using the frame image by one selection of the frame image through the display device.

The printing device according to the invention may have the following structure in addition to the device described above. More specifically, the generator generates the third selection screen information as a page for a markup language, and the generator converts the link into request information for the printing device.

According to an aspect of the invention, the printing device can easily generate a selection screen for the frame image having the acquiring request for the frame printing device by utilizing the selection screen for the frame image received from the server.

The printing device according to the invention may have the following structure in addition to the device described above. More specifically, the acquirer acquires frame image data from a server set or permitted by the display device.

According to an aspect of the invention, the printing device acquires data on the frame image to be used in the frame print or data including the frame image from the server set or permitted by the display device. Therefore, a user can give access to the server on an internet for previously offering data related to the frame print by using the display device, and furthermore, can cause the frame printing device to acquire their data, for example.

According to the present invention there is provided:

a frame printing system comprising:

the printing device according to claim 1;

the display device connected to the printing device through the network, the display device displaying a selection screen for the frame image data in association with the first selection screen information received from the printing device and transmitting information linked to the first frame image data selected on the selection screen to the printing device; and

the server connected to the printing device through the network and supplying the first frame image data to the printing device through the network.

According to an aspect of the invention, the printing system can select the frame image on the server by the display device and can carry out the frame print by using the frame image selected by the display device. As a result, it is possible to perform the frame print in the printing system constituted by the display device and the printing device.

### BRIEF DESCRIPTION OF THE DRAWINGS

FIG. 1 is a diagram showing a frame printing system according to a first embodiment of the invention.

FIG. 2 is an explanatory diagram showing the download page data file of a PIF server.

FIG. 3 is an explanatory diagram showing the menu screen data file of a printer.

FIG. 4 is an explanatory diagram showing the frame image selection screen generating data file of the printer.

FIG. 5 is an explanatory diagram showing the image selection screen generating data file of the printer.

FIG. 6 is an explanatory diagram showing the preview screen generating data file of the printer.

FIG. 7 is a flowchart showing a download processing for the frame printing system.

FIG. 8 is a flowchart showing a frame print processing for the frame printing system.

FIG. 9 is an explanatory diagram showing a download page generated by an HTML page generating unit.

FIG. 10 is an explanatory diagram showing an image synthesis processing to be carried out by an image synthesizing unit.

FIG. 11 is an explanatory diagram showing a menu screen data file according to a second embodiment of the invention.

FIG. 12 is an explanatory diagram showing a download page generated by an HTML page generating unit.

FIG. 13 is a flowchart showing a print processing for the frame printing system (first part).

FIG. 14 is a flowchart showing the print processing for the frame printing system (second part).

### DETAIL DESCRIPTION OF PREFERRED EMBODIMENTS

A frame printing device and a frame printing system according to the invention will be described below with reference to the drawings. The frame printing device will be described by taking a printer as an example.

### Embodiment 1

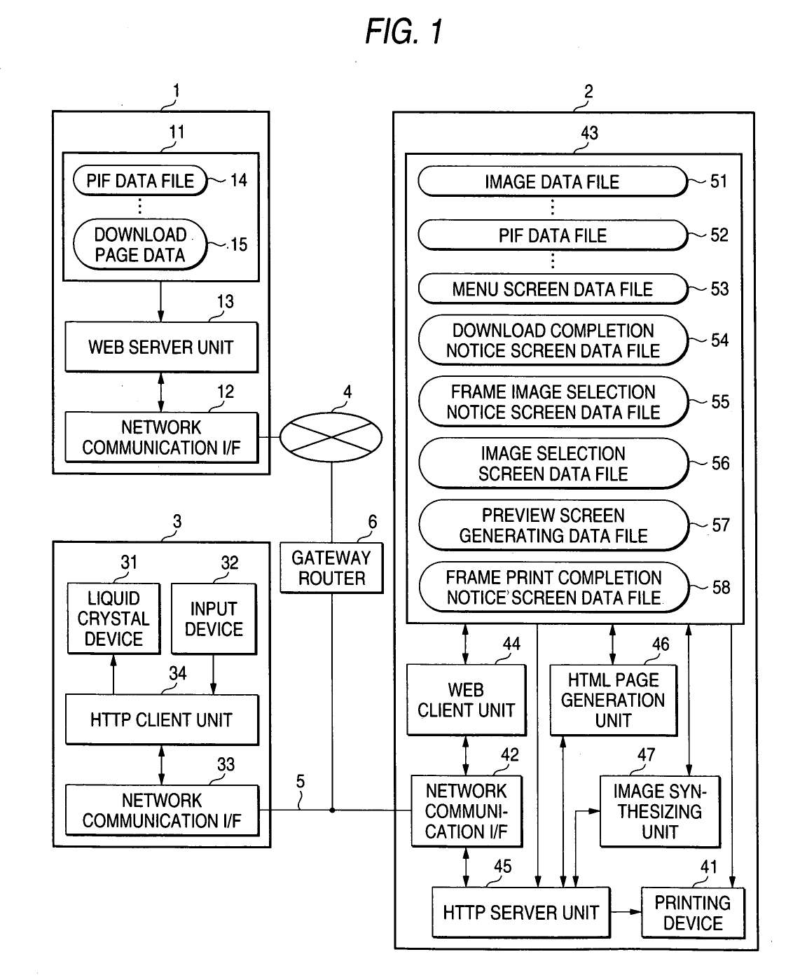

As shown in FIG. 1, the frame printing system has a printer 2 to be a frame printing device which can give access to a PIF (PRINT Image Framer) server 1, and a digital TV receiver 3 to be a display device which can read a page described in HTML (Hyper Text Markup Language). The PIF server 1 is connected to an Internet 4. The printer 2 and the digital TV receiver 3 are connected to a LAN (Local Area Network) 5 to be a network. The LAN 5 and the Internet 4 are connected to a gateway router 6.

The LAN 5 is a computer communication network for connecting a computer or a computer built-in apparatus. The printer 2 and the digital TV receiver 3 are a type of the computer built-in apparatus. The standards of the computer communication network include IEEE (the Institute of Electrical and Electronic Engineers) 802.3, for example. In the IEEE 802.3, for example, it is possible to constitute the computer communication network by connecting each computer to be connected to the LAN 5 to a hub through a cable. The printer 2 and the digital TV receiver 3 may be connected through a wireless LAN using a radio communication line.

The internet 4 is a wide area network having a plurality of LANs 5 connected mutually. For example, a wide area communication line such as a telephone network or a satellite communication line is used for the mutual connection of the LANs 5.

The gateway router 6 receives data on the LAN 5 which are directed to the internet 4 and transmits the data thus received to the Internet 4. The gateway router 6 receives data on the internet 4 which are directed to itself and transmits the data thus received to the LAN 5.

The PIF server 1 has a storage device 11, a network communication I/F 12, and a web server unit 13.

The storage device 11 of the PIF server 1 stores a plurality of PIF data files 14 and a download page data file 15.

The PIF data file 14 has data on a frame image. The frame image is to be superposed on an image in frame print. Some frame images are obtained by changing a frame for setting a photograph into images, for example. As data on each pixel constituting the frame image, frame image data may have a channel data in addition to R (red), G (green) and B (blue) data for representing colors. In the α channel data on each pixel, a transmittance for each pixel is specified.

More specifically, the PIF data file has header data, at least two layer specifying commands, and data on a frame image. One of the at least two layers serves to stick an image. The other layer serves to stick a frame image. Data on the frame image are described after the layer specifying command on the upper side of the layer for sticking an image. The header data have information about a PIF data version, a manufacturer, a copyright holder, a copy enable/disable flag, an edit enable/disable flag, a retrieval keyword, a title, a paper size, and the direction of print (vertical or transverse) with respect to a paper, for example.

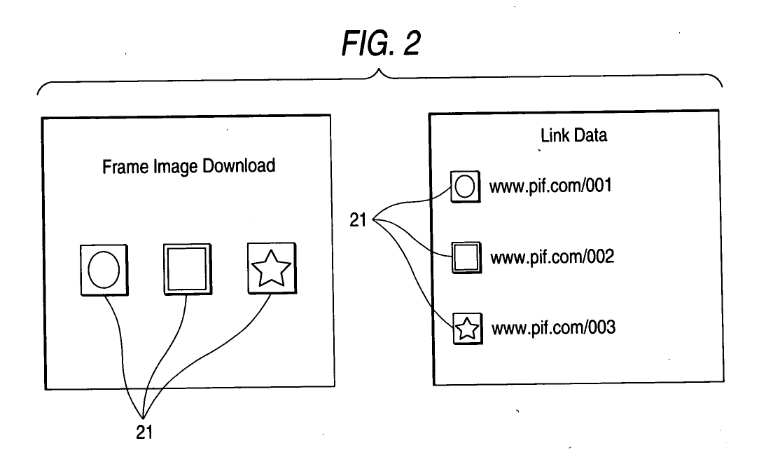

FIG. 2 is a diagram showing an example of a download page generated based on the data of the download page data file 15 in FIG. 1 and link data which are incidental thereto. The download page is a selection page for a frame image to be received by a network communication I/F 42. Download page data are page data described in HTML. On the download page, a character string of “frame image download” is displayed. The download page in FIG. 2 has three reducing image buttons 21.

URL (Uniform Resource Locator) is related to the reducing image button 21 of the download page. The URL to be related is a link described in a markup language, and is described as a resource address in the HTML on the download page data. The URL is present on the internet 4 in the PIF data file 14 stored in the PIF server 1. For example, URL of “www.pif.com/001” is related to the reducing image button 21 on a left side in FIG. 2. “www.pif.com” is URL for the PIF server 1. “001” is an identification number for the PIF data file 14 in the PIF server 1.

Moreover, the reducing image button 21 of the download page has an image obtained by reducing the frame image of the PIF data file 14 which is related. It is sufficient that the image of the reducing image button 21 is image data in a format of JPEG (Joint Photographic Expert Group).

The network communication I/F 12 of the PIF server 1 is connected to the internet 4. The network communication I/F 12 receives data directed to the PIF server 1 from the internet 4. The network communication I/F 12 specifies a transmission destination for data to be transmitted and transmits the same data to the internet 4.

The web server unit 13 reads data to meet a demand from the storage device 11 in accordance with a protocol such as HTTP (HyperText Transfer Protocol) and causes the network communication I/F 12 to transmit the data thus read. A CPU (not shown) in the PIF server 1 executes a web server program so that the web server unit 13 is implemented. It is sufficient that the web server program is stored in the storage device 11 of the PIF server 1. The web server program may be stored in the storage device 11 through a computer readable recording medium or transmitting medium.

The digital TV receiver 3 has a liquid crystal device 31, an input device 32, a network communication I/F 33, and an HTTP client unit 34. The liquid crystal device 31 displays a video for a digital TV broadcast to be received by the digital TV receiver 3. The input device 32 is used for switching a channel for the digital TV broadcast to be received by the digital TV receiver 3.

The network communication I/F 33 of the digital TV receiver 3 is connected to the LAN 5. The network communication I/F 33 receives data directed to the digital TV receiver 3 from the LAN 5. The network communication I/F 33 specifies a transmission destination for data to be transmitted and transmits the same data to the LAN 5.

The HTTP client unit 34 generates a page request for demanding the transmission of a page described in the HTML based on an instruction for input from the input device 32, and supplies the page request thus generated to the network communication I/F 33. The HTTP client unit 34 generates display data from the page described in the HTML and supplies the display data thus generated to the liquid crystal device 31. A CPU (not shown) in the digital TV receiver 3 executes an HTTP client program so that the HTTP client unit 34 is implemented. It is sufficient that the HTTP client program is stored in a storage device (not shown) in the digital TV receiver 3. The HTTP client program is generally prestored in a storage device in the shipment of the digital TV receiver 3.

The printer 2 has a printing device 41, the network communication I/F 42, a storage device 43, a web client unit 44, an HTTP server unit 45, an HTML page generating unit 46, and an image synthesizing unit 47.

The printing device 41 has a paper delivery mechanism and a printing mechanism which are not shown. The printing device 41 controls a paper delivery mechanism and a printing mechanism based on an instruction for printing and prints an image on a paper.

The network communication I/F 42 of the printer 2 is connected to the LAN 5. The network communication I/F 42 receives data directed to the printer 2 from the LAN 5. The network communication I/F 42 specifies a transmission destination for data to be transmitted and transmits the same data to the LAN 5.

The storage device 43 of the printer 2 stores a plurality of image data files 51, a plurality of PIF data files 52, and various screen data files. The storage device 43 of the printer 2 stores, as screen data files, a menu screen data file 53, a download completion notice screen data file 54, a frame image selection screen generating data file 55, an image selection screen generating data file 56, a preview screen generating data file 57, and a frame print completion notice screen data file 58, for example.

The image data file 51 has data on an image. This image is imaged by a DSC which is not shown, for example. Image data have R (red), G (green) and B (blue) data for representing colors as data on each pixel constituting an image.

The PIF data file 52 of the printer 2 is the same as the PIF data file 14 stored in the storage device 11 of the PIF server 1 and description thereof will be omitted.

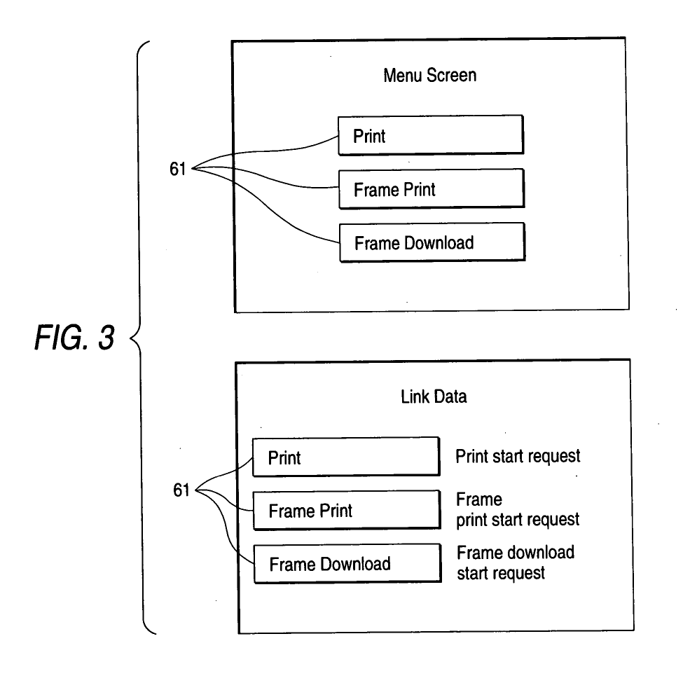

FIG. 3 is a diagram showing an example of a menu screen generated based on the data of the menu screen data file 53 in FIG. 1 and link data which are incidental thereto. A character string of “menu screen” is displayed on the menu screen. The menu screen in FIG. 3 has three menu buttons 61. The three menu buttons 61 are arranged vertically in the screen. A print start request is related to the topmost menu button 61 of the menu screen. The print start request thus related is described as a resource address in the HTML in the menu screen data. The topmost menu button 61 of the menu screen has a character string of “print”. A frame print start request is related as a resource address in the HTML to the middle menu button 61 in the menu screen. The topmost menu button 61 in the menu screen has a character string of “frame print”. A frame download start request is related as the resource address in the HTML to the lowermost menu button 61 in the menu screen. The lowermost menu button 61 in the menu screen has a character string of “frame download”.

The download completion notice screen data file 54 has data on a download completion notice screen. A character string of “a frame image is completely downloaded” is displayed on the download completion notice screen.

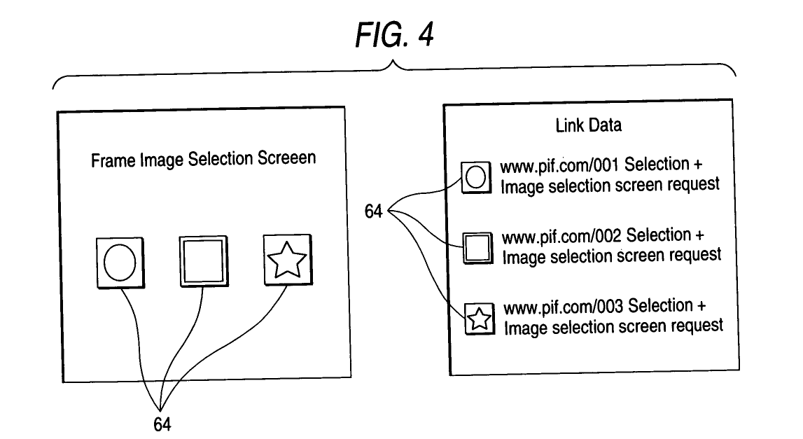

FIG. 4 is a diagram showing an example of a frame image selection screen generated based on the data of the frame image selection screen generating data file 55 in FIG. 1 and link data which are incidental thereto. The frame image selection screen is a selection screen for a frame image which serves to select a frame image to be used for the frame print. A character string of “frame image selection screen” is displayed on the frame image selection screen. The frame image selection screen in FIG. 4 has three reducing image buttons 64. A selection request for the frame image and an image selection screen request are related as the resource address in the HTML to the reducing image button 64 in the frame image selection screen. Moreover, the reducing image button 64 in the frame image selection screen has an image obtained by reducing a frame image thus related. It is sufficient that the image of the reducing image button 64 is image data in the format of JPEG, for example.

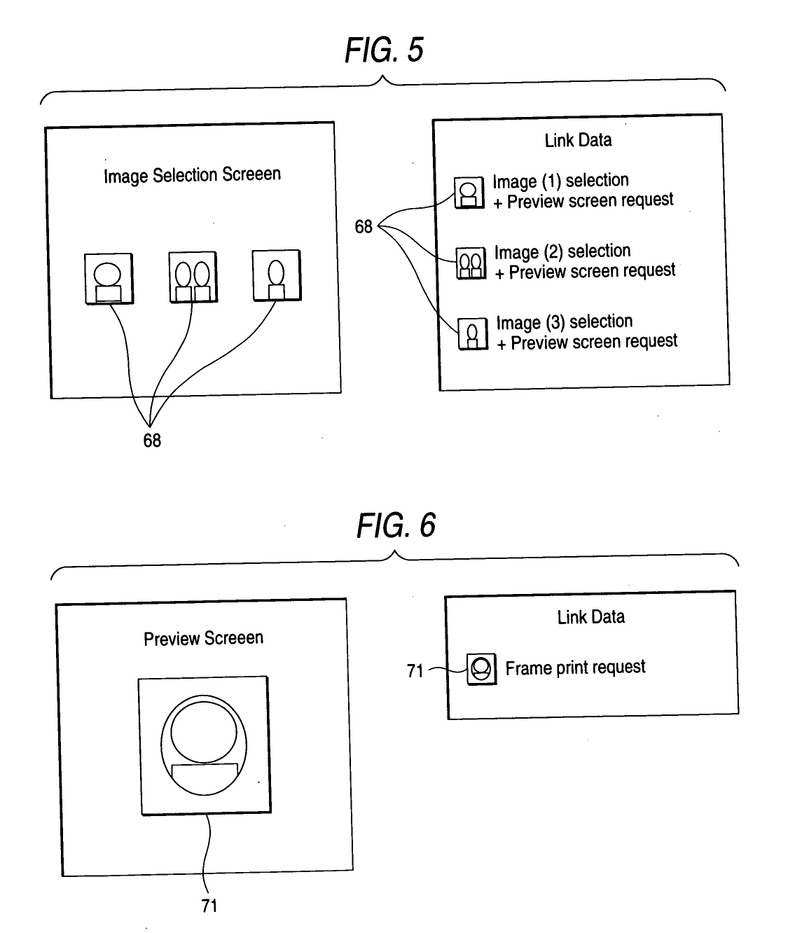

FIG. 5 is a diagram showing an example of an image selection screen generated based on the data of the image selection screen generating data file 56 in FIG. 1 and link data which are incidental thereto. A character string of “image selection screen” is displayed on the image selection screen. The image selection screen in FIG. 5 has three reducing image buttons 68. A selection request for an image and a preview request are related as the resource address in the HTML to the reducing image button 68 in the image selection screen. Moreover, the reducing image button 68 in the image selection screen has an image obtained by reducing an image thus related.

FIG. 6 is a diagram showing an example of a preview screen generated based on the data of the preview screen generating data file 57 in FIG. 1 and link data which are Incidental thereto. The preview screen has a preview image 71. A frame print request for a synthesized image is related as the resource address in the HTML to the preview image 71. Moreover, the preview image 71 has an image obtained by reducing the synthesized image.

The frame print completion notice screen data file 58 has data on a frame print completion notice screen. A character string of “the frame print is completed” is displayed on the frame print completion notice screen.

The web client unit 44 of the printer 2 generates a page request for demanding the transmission of a page on the internet 4 and supplies the page request thus generated to the network communication I/F 42. The web client unit 44 saves the received page data in the storage device 43 in response to the page request.

The HTTP server unit 45 interprets a request for transmitting a page which is described in the HTML. The HTTP server unit 45 reads page data described in the HTML from the storage device 43 based on the interpretation, for example, and causes the network communication I/F 42 to transmit the data thus read.

The HTML page generating unit 46 generates HTML page data by using generation data which are stored in the storage device 43.

The image synthesizing unit 47 synthesizes the frame image of the PIF data file 52 and the image of the image data file 51. The image synthesizing unit 47 saves the synthesized image in the storage device 43.

A CPU (not shown) in the printer 2 executes a printer control program so that the web client unit 44, the HTTP server unit 45, the HTML page generating unit 46 and the image synthesizing unit 47 are implemented. It is sufficient that the printer control program is stored in the storage device 43 of the printer 2. The printer control program is generally prestored in the storage device in the shipment of the printer 2.

Next, description will be given to the operation of the frame printing system shown in FIG. 1.

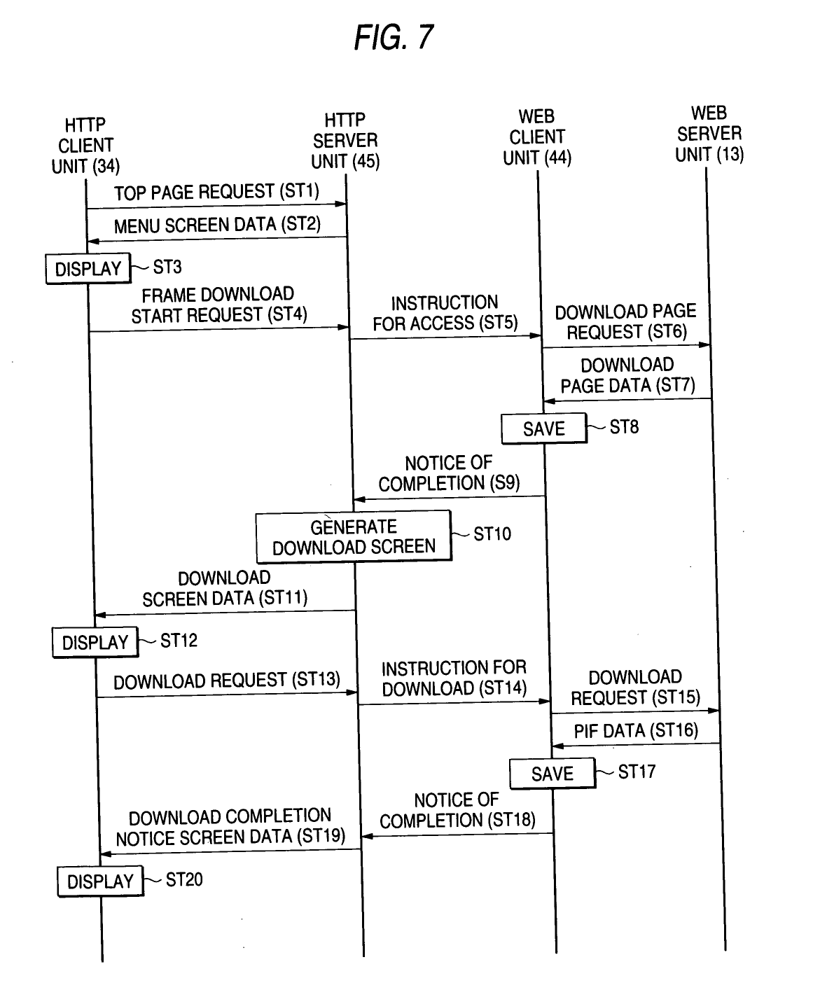

First of all, an operation for downloading a frame image will be described with reference to FIG. 7.

As shown in FIG. 7, the HTTP client unit 34 of the digital TV receiver 3 first generates a top page request for demanding the transmission of a top page to the printer 2 and supplies the top page request thus generated to the network communication I/F 33. The network communication I/F 33 of the digital TV receiver 3 specifies the printer 2 as a transmission destination and transmits the top page request to the LAN 5 (Step ST1).

The network communication I/F 42 of the printer 2 receives, from the LAN 5, the top page request in which a self-machine is specified as the transmission destination. The network communication I/F 42 of the printer 2 supplies the top page request thus received to the HTTP server unit 45. The HTTP server unit 45 interprets the top page request and reads the data of the menu screen data file 53 from the storage device 43 of the printer 2. The HTTP server unit 45 supplies the menu screen data thus read to the network communication I/F 42. The network communication I/F 42 of the printer 2 specifies, as the transmission destination, the digital TV receiver 3 to be the transmission source of the top page request and transmits the menu screen data to the LAN 5 (Step ST2).

The network communication I/F 33 of the digital TV receiver 3 receives, from the LAN 5, the menu screen data in which the self-machine is specified as the transmission destination. The network communication I/F 33 of the digital TV receiver 3 supplies the received menu screen data to the HTTP client unit 34. The HTTP client unit 34 generates display data from the menu screen data and supplies the generated display data to the liquid crystal device 31. The liquid crystal device 31 displays the menu screen shown in FIG. 3 (Step ST3).

The input device 32 of the digital TV receiver 3 outputs an instruction for input corresponding to the operation by a user. The HTTP client unit 34 selects the menu button 61 having a character string of “frame download” based on the instruction for input in a state in which the menu screen shown in FIG. 3 is displayed. The HTTP client unit 34 transmits a frame download start request related to the selected menu button 61 to the HTTP server unit 45 through the network communication I/F 33, the LAN 5 and the network communication I/F 42 of the printer 2 (Step ST4).

The HTTP server unit 45 interprets the frame download start request and gives the web client unit 44 an instruction for accessing the PIF server 1 (Step ST5). The web client unit 44 generates a download page request and supplies the download page request thus generated to the network communication I/F 42. The network communication I/F 42 of the printer 2 specifies the URL of the PIF server 1 on the internet 4 as a transmission destination and transmits the download page request to the LAN 5 (Step ST6).

Information related to the URL of the PIF server 1 and the gateway router 6 (for example, an IP (Internet Protocol) address) is stored in the storage device 43 of the printer 2 based on set information given from the digital TV receiver 3 by means of the HTTP server unit 45, for example. Moreover, the HTTP server unit 45 may store permission to use the URL of the PIF server 1 in the storage device 43 of the printer 2 based on the set information given from the digital TV receiver 3.

In order to carry out these setting operations, moreover, the HTTP server unit 45 may transmit, to the HTTP client unit 34, a set screen for setting the information about the URL of the PIF server 1 and the gateway router 6. In this case, it is sufficient that the HTTP client unit 34 transmits the set information to the HTTP server unit 45 based on the instruction of the input device 32 when the set screen is displayed by the liquid crystal device 31.

The gateway router 6 receives a download page request transmitted from the printer 2 and transmits the data thus received to the internet 4. The network communication I/F 12 of the PIF server 1 receives, from the internet 4, a download page request in which the self-machine is specified as the transmission destination and supplies the download page request thus received to the web server unit 13.

The web server unit 13 of the PIF server 1 interprets the download page request and reads the data of the download page data file 15 from the storage device 11 of the PIF server 1. The web server unit 13 supplies the read download page data to the network communication I/F 12. The network communication I/F 12 specifies, as a transmission destination, the gateway router 6 to be a transmission source in the internet 4 of the download page request and transmits the download page data to the internet 4 (Step ST7).

The gateway router 6 receives, from the internet 4, the download page data in which the self-machine is specified as the transmission destination The gateway router 6 specifies the printer 2 as the transmission destination for the download page data to be received from the internet 4 and transmits the download page data to the LAN 5. The network communication I/F 42 of the printer 2 receives the download page data from the LAN 5 and supplies the same download page data to the web client unit 44. The web client unit 44 saves the download page data in the storage device 43 (Step ST8). The web client unit 44 gives a notice for the completion of the receipt of the download page data to the HTTP server unit 45 (Step ST9).

When the notice of the completion is given from the web client unit 44, the HTTP server unit 45 of the printer 2 gives an instruction for generating download page data for the digital TV receiver 3 (Step ST10). The HTML page generating unit 46 generates the download page data for the digital TV receiver 3 from the download page data saved in the storage device 43. In the case in which the data on the image of the reducing image button 21 in the download page data which are saved in the storage device 43 are not image data in the format of JPEG, the same image data are converted into the image data in the format of JPEG.

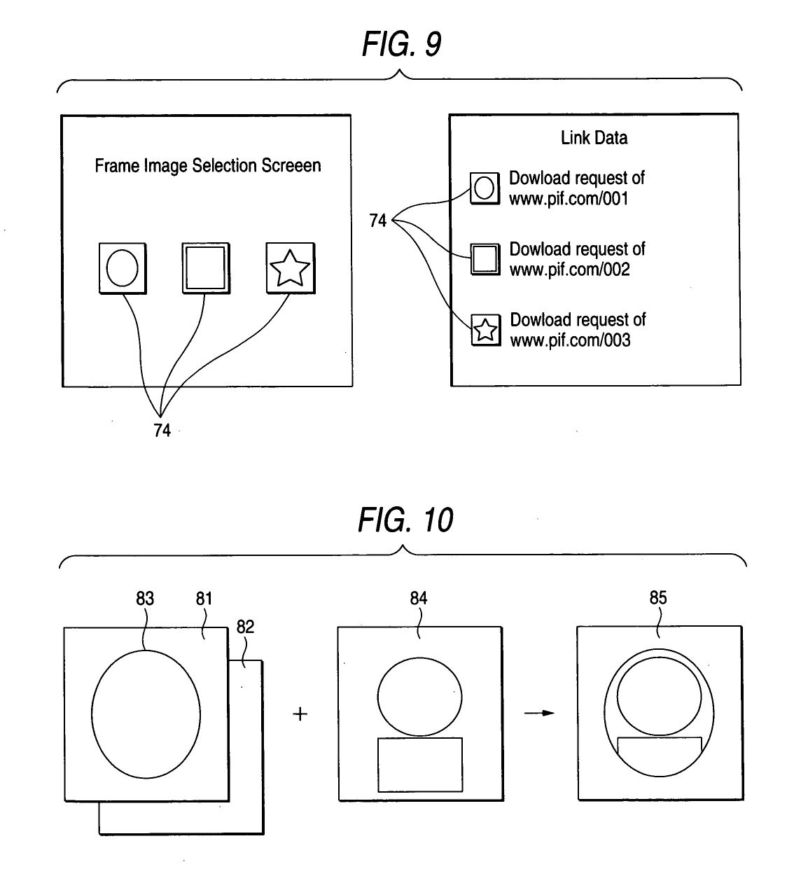

FIG. 9 is a diagram showing an example of the download page data for the digital TV receiver 3 which are generated by the HTML page generating unit 46 based on the download page data in FIG. 2 and link data which are incidental thereto. The download page is a selection screen for a frame image. The HTML page generating unit 46 converts the URL of the download page data received from the PIF server 1 which are related to each of reducing image buttons 74 into a download request for a frame image given from the URL for the printer 2.

More specifically, for example, the HTML page generating unit 46 converts URL of “www.pif.com/001” to a “download request of www.pif.com/001” for the reducing image button 74 on a left side in FIG. 9.

The download page data in FIG. 9 are the same as the download page data in FIG. 2 in that the download page has a character string of “frame image download” and the three reducing image buttons 74 and that the reducing image button 74 has an image obtained by reducing the frame image of the PIF data file 14 stored in the PIF server 1.

Thus, the HTML page generating unit 46 can easily generate a selection screen for a frame image having a download request for the printer 2 by utilizing the selection screen for the frame image shown in FIG. 2 which is received from the internet.

The HTTP server unit 45 of the printer 2 transmits the download page data for the digital TV receiver 3 which are generated from the HTML page generating unit 46 to the HTTP client unit 34 of the digital TV receiver 3 through the network communication I/F 42, the LAN 5 and the network communication I/F 33 (Step ST11).

The HTTP client unit 34 receives the download page data for the digital TV receiver 3 which are generated by the HTML page generating unit 46, generates display data from the download page data thus received, and supplies the display data thus generated to the liquid crystal device 31. The liquid crystal device 31 displays the frame image download screen shown in FIG. 9 (Step ST12).

The HTTP client unit 34 selects one of the reducing image buttons 74 based on an instruction for input given from the input device 32 in a state in which the frame image download screen shown in FIG. 9 is displayed. The HTTP client unit 34 transmits the download request of a frame image related to the reducing image button 74 thus selected to the HTTP server unit 45 through the network communication I/F 33 of the digital TV receiver 3, the LAN 5 and the network communication I/F 42 of the printer 2 (Step ST13).

The HTTP server unit 45 of the printer 2 interprets the download request of the frame image. The HTTP server unit 45 gives the web client unit 44 an instruction for downloading PIF data in relation to the download request (Step ST14). The web client unit 44 generates a download request for the PIF data. The download request thus generated is transmitted to the web server unit 13 of the PIF server 1 through the network communication I/F 42 of the printer 2, the LAN 5, the gateway router 6, the Internet 4 and the network communication I/F 12 of the PIF server 1 (Step ST15).

The web server unit 13 of the PIF server 1 interprets the download request thus received and reads the data of the PIF data file 14 related to the download request from the storage device 11. The PIF data thus read are transmitted to the web client unit 44 of the printer 2 through the network communication I/F 12 of the PIF server 1, the Internet 4, the gateway router 6, the LAN 5 and the network communication I/F 42 of the printer 2 (Step ST16). The web client unit 44 of the printer 2 saves the PIF data thus received as the PIF data file 52 in the storage device 43 (Step ST17) and gives a notice of the completion of the download of the PIF data to the HTTP server unit 45 (Step ST18).

When the notice of the completion of the download of the PIF data is given from the web client unit 44, the HTTP server unit 45 of the printer 2 reads the download completion notice screen data file 54 from the storage device 43. The HTTP server unit 45 transmits the download completion notice screen data to the HTTP client unit 34 through the network communication I/F 42 of the printer 2, the LAN 5, and the network communication I/F 33 of the digital TV receiver 3 (Step ST19). The HTTP client unit 34 generates display data from the download completion notice screen data and supplies the display data thus generated to the liquid crystal device 31. The liquid crystal device 31 displays the frame image download completion notice screen (Step ST20). A character string of “a frame image is completely downloaded” is displayed on the liquid crystal device 31.

By the processing described above, the PIF data on the frame image selected by the digital TV receiver 3 are stored in the storage device 43 of the printer 2. The PIF data file 52 having the same PIF data as those stored in the PIF server 1 is saved in the storage device 43 of the printer 2.

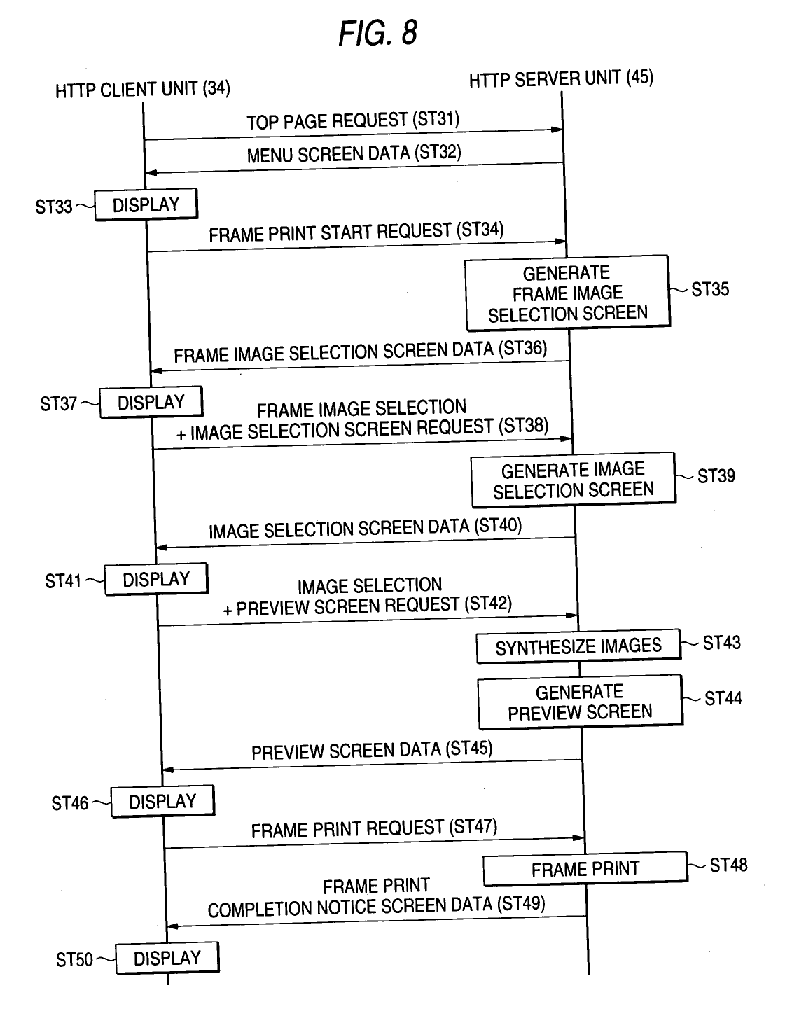

Referring to FIG. 8, next, description will be given to a frame print processing for an image which uses the PIF data stored in the storage device 43 of the printer 2.

As shown in FIG. 8, the HTTP client unit 34 of the digital TV receiver 3 first generates a top page request for giving a request for transmitting a top page to the printer 2 and transmits the top page request to the HTTP server unit 45 of the printer 2 (Step ST31). The HTTP server unit 45 reads the data of the menu screen data file 53 from the storage device 43 and transmits the menu screen data thus read to the HTTP client unit 34 (Step ST32). The HTTP client unit 34 generates display data from the menu screen data. The liquid crystal device 31 displays the menu screen shown in FIG. 3 (Step ST33).

The HTTP client unit 34 selects the menu button 61 having the character string of “frame print” based on an instruction for input by the input device 32 in a state in which the menu screen shown in FIG. 3 is displayed. The HTTP client unit 34 transmits a frame print start request related to the menu button 61 thus selected to the HTTP server unit 45 of the printer 2 (Step ST34). The HTTP server unit 45 gives an instruction for generating a frame image selection screen to the HTML page generating unit 46 (Step ST35). The HTML page generating unit 46 generates frame image selection screen data by using the data of the frame image selection screen generating data file 55 and a plurality of frame images of the PIF data files 52 which are stored in the storage device 43. The PIF data files 52 include a file of the PIF data downloaded from the PIF server 1.

The HTTP server unit 45 transmits the frame image selection screen data generated by the HTML page generating unit 46 to the HTTP client unit 34 (Step ST36). The HTTP client unit 34 generates display data based on the frame image selection screen data. The liquid crystal device 31 displays the frame image selection screen shown in FIG. 4 (Step ST37). The frame image selection screen displayed on the liquid crystal device 31 has a plurality of reducing image buttons 64. An instruction for selecting each of the PIF data files 52 stored in the storage device 43 of the printer 2 is related to the reducing image button 64, and furthermore, the frame image of the same PIF data file 52 is allocated thereto.

The HTTP client unit 34 selects a predetermined one of the reducing image buttons 64 based on an instruction for input given from the input device 32 in a state in which the frame image selection screen shown in FIG. 4 is displayed. The HTTP client unit 34 transmits an instruction for selecting the PIF data file 52 related to the reducing image button 64 thus selected to the HTTP server unit 45 of the printer 2 (Step ST38). The HTTP server unit 45 specifies the PIF data file 52 which is selected. Moreover, the HTTP server unit 45 gives an instruction for generating an image selection screen to the HTML page generating unit 46 (Step ST39). The HTML page generating unit 46 generates image selection screen data by using the data of the image selection screen generating data file 56 stored in the storage device 43 and a plurality of images of the image data files 51.

The HTTP server unit 45 transmits the image selection screen data generated by the HTML page generating unit 46 to the HTTP client unit 34 (Step ST40). The HTTP client unit 34 generates display data based on the image selection screen data. The liquid crystal device 31 displays the image selection screen shown in FIG. 5 (Step ST41). The image selection screen displayed on the liquid crystal device 31 has a plurality of reducing image buttons 68. An instruction for selecting each of the image data files 51 stored in the storage device 43 of the printer 2 is related to the reducing image button 68, and furthermore, the image of the image data file 51 is allocated thereto. It is sufficient that the image of the reducing image button 68 is image data in the format of JPEG, for example.

The HTTP client unit 34 selects a predetermined one of the reducing image buttons 68 based on an instruction for input given by the input device 32 in a state in which the image selection screen shown in FIG. 5 is displayed. The HTTP client unit 34 transmits an instruction for selecting the image data file 51 related to the reducing image button 68 thus selected to the HTTP server unit 45 of the printer 2 (Step ST42). The HTTP server unit 45 specifies the image data file 51 thus selected.

Moreover, the HTTP server unit 45 designates the PIF data file 52 which is specified earlier and the image data file 51 which is specified, and gives an instruction for synthesizing images to the image synthesizing unit 47 (Step ST43). The image synthesizing unit 47 generates a synthesized image obtained by superposing the frame image of the PIF data file 52 which is designated on the image of the image data file 51 which is designated. The image synthesizing unit 47 saves the synthesized image in the storage device 43.

FIG. 10 is a diagram for explaining an image synthesis processing to be carried out by the image synthesizing unit 47 in FIG. 1. The image synthesizing unit 47 generates two layers including a first layer 81 and a second layer 82 based on two layer designating commands of the PIF data. The first layer 81 and the second layer 82 are generated in sizes corresponding to a paper size designated by header data, for example. Next, the image synthesizing unit 47 sticks a frame image 83 to the first layer 81 on an upper side. At this time, a transmittance for each pixel is also designated in the first layer 81. Then, the image synthesizing unit 47 sticks an image 84 of the image data file 51 to the second layer 82 on a lower side. Finally, the image synthesizing unit 47 synthesizes the first layer 81 and the second layer 82. By the processing described above, the image synthesizing unit 47 generates a synthesized image 85 by superposing the frame image 83 on the image 84 of the image data file 51.

When the image synthesizing unit 47 saves the synthesized image 85 in the storage device 43, the HTML page generating unit 46 generates preview screen data for displaying the synthesized image 85 by using the synthesized image 85 and the data of the preview screen generating data file 57 (Step ST44).

The HTTP server unit 45 transmits the preview screen data generated by the HTML page generating unit 46 to the HTTP client unit 34 (Step ST45). The HTTP client unit 34 generates display data based on the preview screen data. The liquid crystal device 31 displays a preview screen shown in FIG. 6 (Step ST46). The preview screen displayed on the liquid crystal device 31 has the preview image 71. The frame print request of the synthesized image 85 is related to the preview image 71, and furthermore, an image obtained by enlarging or reducing the synthesized image 85 to have a predetermined size is allocated thereto.

The HTTP client unit 34 selects the preview image 71 based on the instruction for input given by the input device 32 in a state in which the preview screen shown in FIG. 6 is displayed. The HTTP client unit 34 transmits a frame print request related to the preview image 71 thus selected to the HTTP server unit 45 of the printer 2 (Step ST47).

The HTTP server unit 45 gives an instruction for printing the synthesized image 85 generated by the image synthesizing unit 47 to the printing device 41 upon receipt of the frame print request. The printing device 41 controls a paper delivery mechanism and a printing mechanism based on the instruction for the print and prints, on a paper, the synthesized image 85 which is designated (step ST48).

The HTTP server unit 45 reads the data of the frame print completion notice screen data file 58 from the storage device 43 and transmits the frame print completion notice screen data thus read to the HTTP client unit 34 (Step ST49). The HTTP client unit 34 generates display data based on the frame print completion notice screen data. A character string of “the frame print is completed” is displayed on the liquid crystal device 31 (Step ST50).

By the processing described above, the frame printing system according to the first embodiment can download the frame image 83 selected by the digital TV receiver 3 from the PIF server 1 present on the internet 4 to the printer 2, and can print, on a paper, the image 85 obtained by synthesizing the frame image 83 thus downloaded and the image 84 selected by the digital TV receiver 3 before the frame print.

In addition, the frame printing system according to the first embodiment can immediately start the frame print by using the frame image which has already been acquired by the printer 2 when the frame image 83 to be printed is selected by the digital TV receiver 3.

Moreover, the printer 2 of the frame printing system according to the first embodiment can set or permit the PIF server 1 for acquiring the PIF data to be used for the frame print by means of the digital TV receiver 3. For example, therefore, a user previously gives access to the PIF server 1 by using the digital TV receiver 3, and furthermore, can cause the printer 2 to acquire the PIF data.

By previously confirming that the selection screen for the frame image shown in FIG. 2 can be displayed on the digital TV receiver 3, particularly, the user can reliably acquire a frame image which can be selected on the selection screen for the frame image and can carry out the frame print using the frame image.

### Second Embodiment

A frame printing system according to a second embodiment of the invention has a printer 2 capable of giving access to a PIF server 1, and a digital TV receiver 3. The PIF server 1 is connected to an internet 4. The printer 2 and the digital TV receiver 3 are connected to a LAN 5. The internet 4 and the LAN 5 are connected to a gateway router 6. These components are the same as the components having the same names in the first embodiment and have the same reference numerals, and description will be omitted.

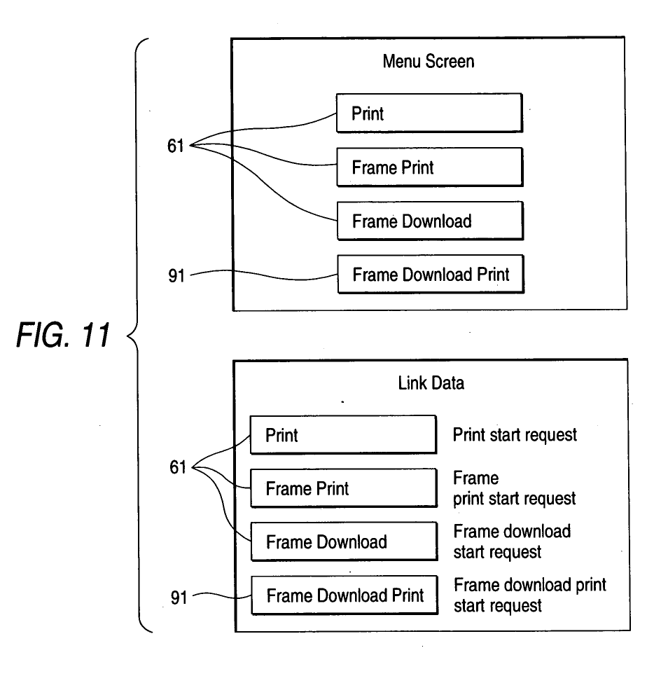

FIG. 11 is a diagram showing an example of a menu screen generated based on the data of a menu screen data file 53 stored in the storage device of the printer according to the second embodiment of the invention and link data which are incidental thereto. The menu screen has a menu button 91. A frame download print start request is related to the menu button 91. The frame download print start request thus related is described as a resource address in HTML in menu screen data. The menu button 91 has a character string of “frame download print”. The other menu screens shown in FIG. 11 and link data which are incidental thereto are the same as those shown in FIG. 3 and have the same reference numerals, and description will be omitted.

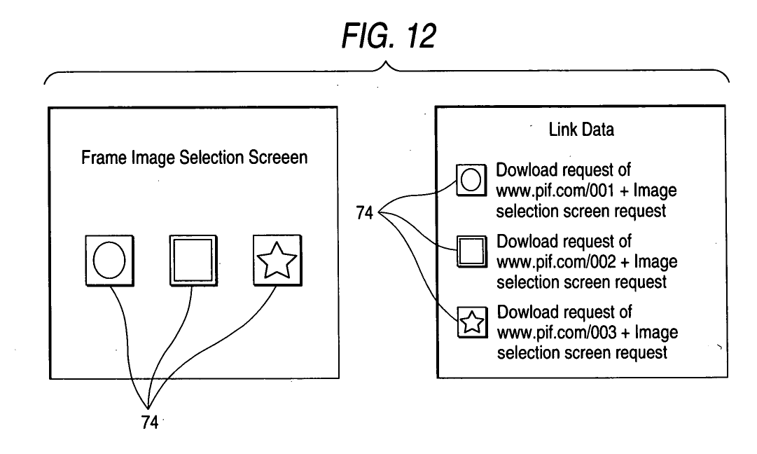

FIG. 12 is a diagram showing an example of download page data for the digital TV receiver 3 which are generated by an HTML page generating unit 46 based on download page data downloaded from the PIF server 1 and link data which are incidental thereto. The frame image selection screen is a selection screen for a frame image which serves to select a frame image to be printed. A “download request of www.pif.com/001” and an “image selection screen request” are related to the reducing image button 74 on a left side in FIG. 9. A “download request of www.pif.com/002” and the “image selection screen request” are related to the reducing image button 74 in the middle of FIG. 9. A “download request of www.pif.com/003” and the “image selection screen request” are related to the reducing image button 74 on a right side in FIG. 9.

Components other than the PIF server 1, the printer 2 and the digital TV receiver 3 are identical to the components having the same names according to the first embodiment shown in FIG. 1 and have the same reference numerals, and description will be omitted.

Next, description will be given to the operation of the frame printing system according to the second embodiment of the invention.

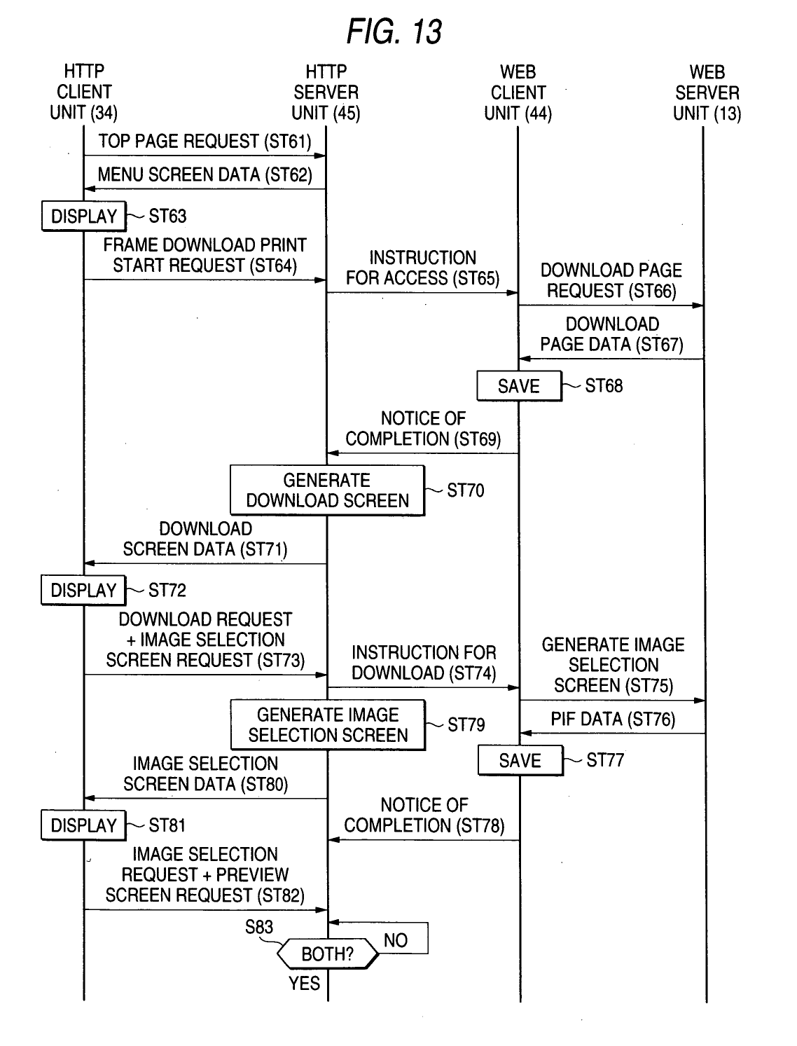

As shown in FIG. 13, an HTTP client unit 34 of the digital TV receiver 3 first transmits a top page request to an HTTP server unit 45 of the printer 2 (Step ST61). The top page request is transmitted to the HTTP server unit 45 through a network communication I/F 33 of the digital TV receiver 3, the LAN 5 and a network communication I/F 42 of the printer 2. The HTTP server unit 45 reads the data of the menu screen data file 53 from a storage device and transmits the same data to the HTTP client unit 34 of the digital TV receiver 3 (Step ST62). The HTTP client unit 34 displays the menu screen shown in FIG. 11 on a liquid crystal device 31 (Step ST63).

When selecting the menu button 91 having a character string of “frame download print” based on an instruction for input of an input device 32, the HTTP client unit 34 transmits a frame download print start request related to the selected menu button 91 to the HTTP server unit 45 (Step ST64). The HTTP server unit 45 gives a web client unit 44 an instruction for giving access to the PIF server 1 (Step ST65). The web client unit 44 transmits a download page request to a web server unit 13 of the PIF server 1 (Step ST66).

The web server unit 13 reads the data of a download page data file 15 from a storage device 11 and transmits the data thus read to the web client unit 44 (Step ST67). The web client unit 44 saves the download page data thus received in a storage device 43 of the printer 2 (Step ST68) and gives a notice of the completion of the receipt of the download page data to the HTTP server unit 45 (Step ST69). The HTTP server unit 45 causes an HTML page generating unit 46 to generate download page data for the digital TV receiver 3 (Step ST70) and transmits the data thus generated to the HTTP client unit 34 (Step ST71). The HTTP client unit 34 causes a liquid crystal device to display a frame image download screen shown in FIG. 12 (Step ST72).

The HTTP client unit 34 selects one of reducing image buttons 74 based on an instruction for input given from the input device 32 in a state in which the frame image download screen shown in FIG. 12 is displayed. The HTTP client unit 34 transmits, to the HTTP server unit 45, a download request for a frame image which is related to the reducing image button 74 thus selected and an image selection screen request (Step ST73).

The HTTP server unit 45 gives the web client unit 44 an instruction for downloading PIF data related to the download request for the frame image based on the download request (Step ST74). The web client unit 44 transmits the download request for the PIF data to the web server unit 13 (Step ST75). The web server unit 13 reads the data of a PIF data file 14 related to the download request from the storage device 11 and transmits the data thus read to the web client unit 44 (Step ST76). The web client unit 44 saves the received PIF data in the storage device 43 of the printer 2 (Step ST77) and gives a notice of the completion of the download of the PIF data to the HTTP server unit 45 (Step ST78).

Moreover, the HTTP server unit 45 causes the HTML page generating unit 46 to generate image selection screen data based on the image selection screen request (Step ST79) and transmits the data thus generated to the HTTP client unit 34 (Step ST80). The HTTP client unit 34 causes the liquid crystal device 31 to display the image selection screen based on the received image selection screen data (see FIG. 5) (Step ST81).

When selecting a predetermined one of reducing image buttons 68 based on an instruction for input given by the input device 32 in a state in which the image selection screen shown in FIG. 5 is displayed, the HTTP client unit 34 transmits, to the HTTP server unit 45, an instruction for selecting an image data file 51 related to the same button (Step ST82).

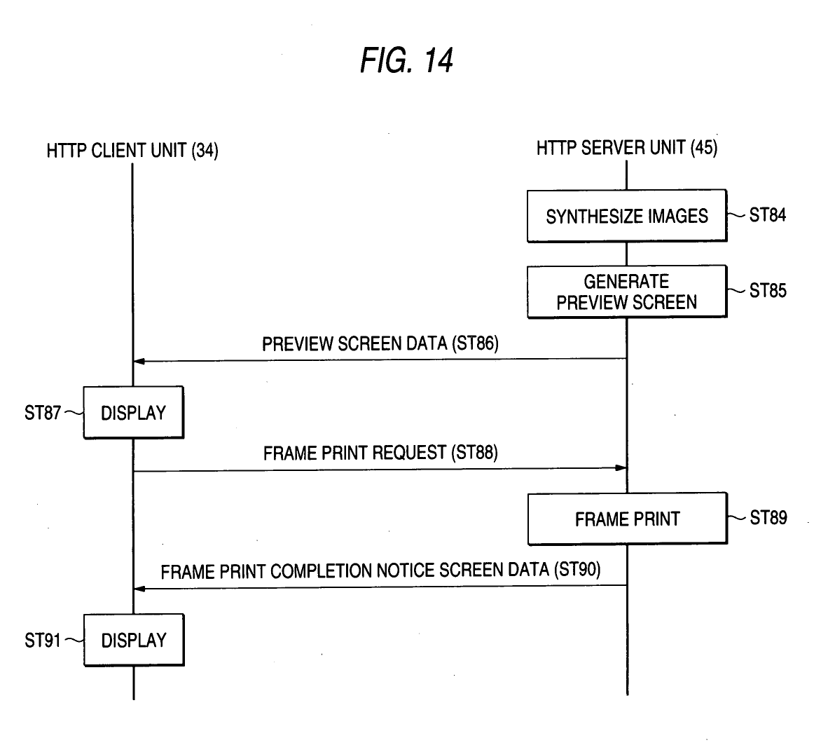

When the HTTP server unit 45 confirms that both the instruction for selecting the image data file 51 and the notice of the completion of the download of the PIF data are present (Step ST83), the PIF data thus downloaded and the selected image data are designated to cause an image synthesizing unit 47 to synthesize images as shown in FIG. 14 (Step ST84). The HTTP server unit 45 causes the HTML page generating unit 46 to generate preview screen generating data for confirming a synthesized image 85 (Step ST85) and to transmit the preview screen generating data thus generated to the HTTP client unit 34 (Step ST86). The HTTP client unit 34 causes the liquid crystal device 31 to display a preview screen (see FIG. 6) based on preview screen data (see FIG. 6) (Step ST87).

When selecting a preview image 71 based on an instruction for input given by the input device 32 in a state in which the preview screen shown in FIG. 6 is displayed, the HTTP client unit 34 transmits a frame print request to the HTTP server unit 45 (Step ST88). The HTTP server unit 45 causes a printing device 41 to print a synthesized image (Step ST89). Consequently, the synthesized image is printed on a predetermined paper.

After an instruction for the print is given, the HTTP server unit 45 reads the data of a frame print completion notice screen data file 58 from the storage device 43 and transmits the data thus read to the HTTP client unit 34 (Step ST90). The HTTP client unit 34 causes the liquid crystal device 31 to display a character string of “Frame print is completed” (Step ST91).

By the processing described above, the frame printing system according to the second embodiment can download the PIF data (frame image) from the PIF server 1 present on the Internet 4 to the printer 2 and can print, on a paper, the image 85 obtained by synthesizing a frame image 83 thus downloaded and an image 84 selected in the digital TV receiver 3 in the frame print.

In addition, the frame printing system according to the second embodiment can execute the acquirement of the frame image 83 and the print using the frame image 83 by once selecting the frame image 83 by means of the digital TV receiver 3.

While each of the embodiments is an example of suitable embodiments according to the invention, the invention is not restricted thereto but various changes and modifications can be made without departing from the scope of the invention.

For example, in each of the embodiments, the image data and various screen data files are stored in the storage device 43 provided in the printer 2. In addition, these data may be stored in the printer 2 and a portable storage medium such as a removable semiconductor memory. The image data may be stored in the digital TV receiver 3.

In each of the embodiments, the HTML page generating unit 46 of the printer 2 converts the download page data acquired from the PIF server 1 on the internet 4 into the page data described in the HTML, and transmits the data thus converted to the digital TV receiver 3 and displays the same data. In addition, for example, in the case in which the digital TV receiver 3 can display data in a format other than the page data described in the HTML, the printer 2 may convert the download page data acquired from the PIF server 1 on the internet 4 into data in the other format.

In each of the embodiments, the printer 2 downloads the PIF data selected in the digital TV receiver 3 from the PIF server 1. In addition, for example, the printer 2 may automatically download a plurality of PIF data in a batch from the PIF server 1 based on the download request given from the digital TV receiver 3.

In each of the embodiments, the digital TV receiver 3 is connected to the printer 2, and an image to be frame printed and a frame image are selected in the digital TV receiver 3. In addition, for example, it is also possible to connect, to the printer 2, a display device capable of reading a page described in the HTML such as a cell phone terminal having a color liquid crystal or a PDA (Personal Digital Assistants) device.

The invention can be utilized in a frame printing system connected to a network obtained by connecting a digital TV receiver and a printer to an internet and serving to carry out printing by using a frame image acquired from the internet based on the selection of the digital TV receiver.

What is claimed is:

1. A printing device storing image data, the printing image comprising:
a communicator connected, through a network, to a predetermined server including first frame image data and to a display device operable to select the first frame image data in association with first selection screen information linked to the first frame image data;
an acquirer adapted to acquire the first frame image data from the predetermined server through the communicator;
a transmitter adapted to transmit the first selection screen information to the display device through the communicator; and
a printer adapted to print an image on a medium in association with the image data and the first frame image data selected by the display device.

2. The printing device according to claim 1, further comprising:
a receiver adapted to receive second selection screen information having a link linked to second frame image data from the predetermined server through the communicator; and
a generator adapted to convert the link into request information so as to generate third selection screen information having the request information, wherein
the acquirer receives one of the request information from the display device and acquires one of the second frame image data corresponding to the one of the request information from the predetermined server, and
the transmitter transmits forth selection screen information having the second frame image data to the display.

3. The printing device according to claim 2, wherein
the generator generates the third selection screen information as a page for a markup language, and
the generator converts the link into request information for the printing device.

4. The printing device according to claim 1, further comprising:
a receiver adapted to receive second selection screen information having a link linked to second frame image data from the predetermined server through the communicator; and
a generator adapted to convert the link into request information so as to generate third selection screen Information having the request information, wherein
the acquirer receives first one of the request information from the display device and acquires one of the second frame image data corresponding to the first one of the request information from the predetermined server, and
the transmitter transmits forth selection screen information having the one of the second frame image data and generated by the generator in association with second one of the request information, to the display.

5. The printing device according to claim 1, wherein
the acquirer acquires frame image data from a server set or permitted by the display device.

6. A frame printing system comprising:
the printing device according to claim 1;
the display device connected to the printing device through the network, the display device displaying a selection screen for the frame image data in association with the first selection screen information received from the printing device and transmitting information linked to the first frame image data selected on the selection screen to the printing device; and
the server connected to the printing device through the network and supplying the first frame image data to the printing device through the network.
